(19) United States
(12) Patent Application Publication
(10) Pub. No.: US 2010/0302119 A1
(43) Pub. Date: Dec. 2, 2010

(54) Antenna Arrangement

(75) Inventor: Jan-Willem ZWEERS, Nieuwleusen (NL)

Correspondence Address: SNYDER, CLARK, LESCH & CHUNG, LLP, 950 Herndon Parkway, Suite 365, HERNDON, VA, 20170, US

(73) Assignee: SONY ERICSSON MOBILE COMMUNICATIONS AB, Lund (SE)

(21) Appl. No.: 12/471,713

(22) Filed: May 26, 2009

(51) Int. Cl. H01Q 21/08

(52) U.S. Cl. 343/824

(57) ABSTRACT

An enhanced antenna system may include at least two antenna elements distanced from each other and substantially in parallel and connected to a common input/output port for said antenna system. Each of said antenna elements may include a portion having an impedance such that the impedance is influenced by an external load such that one of the at least two antennas closest to said load is influenced by said load and detuned.

### TECHNICAL FIELD

The present invention relates to antennas and especially to antennas for mobile devices located close to an object interfering with an antenna's properties.

### BACKGROUND

Wearable electronics are an emerging trend in consumer communication systems. Devices worn on the body communicate with each other via local wireless links like Bluetooth, and to local access points via WLAN. A challenge in these systems is to form the antennas since they need to be small and there is usually a large impact from the body. For handheld devices, it is well known that the influence of the human head or the hand can greatly impact the efficiency of the antenna. For handhelds, careful design and placement of the antenna in the product is essential. For wearable devices including headsets, watches, radio clips, etc., this is even more difficult, since it cannot always be predicted beforehand how the user is going to wear the product. That is, the user decides how to wear the product.

When the antenna is close to the body, the antenna efficiency is greatly degraded, as illustrated in FIG. 1. According to this example, the radio frequency (RF) absorption of the body results in an efficiency loss of 3 dB at 1 cm from the body and of 16 dB at 2 mm from the body measured at 2.5 GHz.

Antenna diversity is one solution to address the body effect. FIG. 2 shows a communication device 200 having two antenna elements 210 and 220, respectively, one of which (here 220), is always far away from the body 290. An antenna switch mechanism 230 can be used, such that the radio 240 will always select one of the antennas to be the active antenna element. Switch controlled antenna diversity may have some major drawbacks:
Extra printed circuit board (PCB) area for the switch
Sensitivity for Electro Static Discharge
Extra energy use
A need for control hardware
A need for a software control algorithm
Extra response time due to sensing the antenna performance
Extra cost of the switch.

### SUMMARY

The invention addresses the problem of reduced antenna efficiency in wearable devices due to the body effect. Thus, a new method and arrangement is presented that automatically selects the best antenna element in a multi-antenna device to compensate for body effects without a need for additional hardware. With this technique, the average antenna efficiency is improved as compared to only one antenna systems.

For these reasons, an antenna system is provided comprising at least two antenna elements distanced from each other and arranged substantially in parallel and connected to a common input/output for the antenna system. Each of the antenna elements comprises a portion having an impedance such that the impedance is influenced by an external load such that one of the at least two antennas elements closest to the load is influenced by the load and detuned. When the antenna element is detuned it results in an optimal driving of the second antenna element. The object may be a human body portion. Preferably, the antenna elements are configured to operate as a closely coupled antenna array, wherein the antenna elements have same resonance frequency, and their reflection coefficient response coincide when there is no load influencing them.

Aspects of the invention also relate to a communication device comprising a transceiver portion and an antenna system comprising at least two antenna elements arranged distanced from each other and substantially in parallel and connected to a common input/output port for the antenna system. Each of the antenna elements comprises a portion having an impedance such that the impedance is influenced by an external load such that one of the at least two antennas closest to the load is influenced by the load and detuned. When the antenna element is detuned, it results in an optimal driving of the second antenna element. The object may be a human body portion. The antenna elements are configured to operate as a closely coupled antenna array, wherein the antenna elements have the same resonance frequency, and their reflection coefficient response coincide when there is no load influencing them.

Aspects of the invention also relate to a method of enhancing radiation efficiency of an antenna system. The method comprises: providing at least two antenna elements distanced from each other and arranged substantially in parallel and connected to a common input/output and providing the antenna elements with a portion having an impedance such that the impedance is influenced by an external load such that one of the at least two antennas closest to the load is influenced by the load and detuned.

### BRIEF DESCRIPTION OF THE DRAWINGS

The present invention will hereinafter be further explained by means of non-limiting examples with reference to the appended figures where:

FIG. 1 is a graph illustrating impact of the body for a half-wavelength dipole at 2.5 GHz,

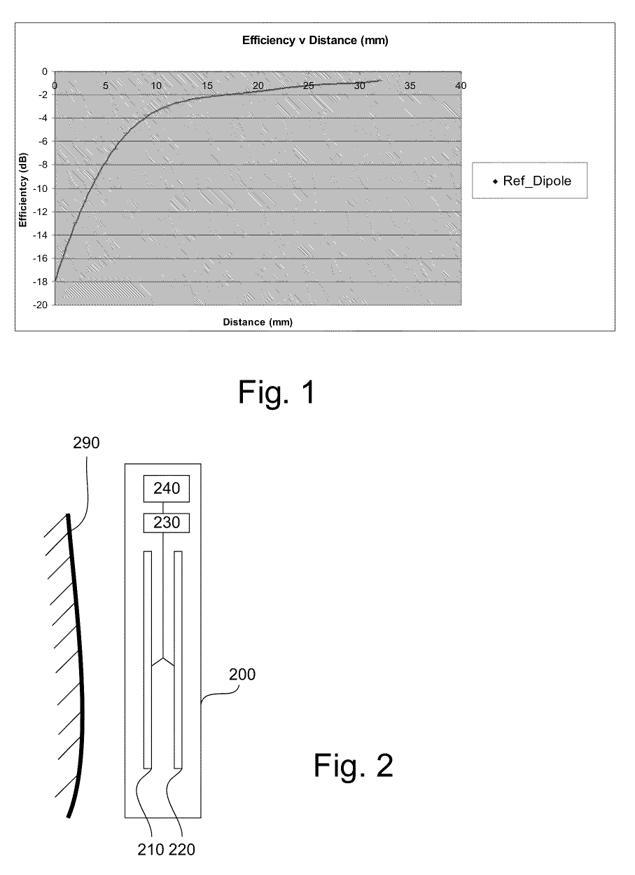

FIG. 2 is a schematic diagram illustrating antenna diversity to address the body effect,

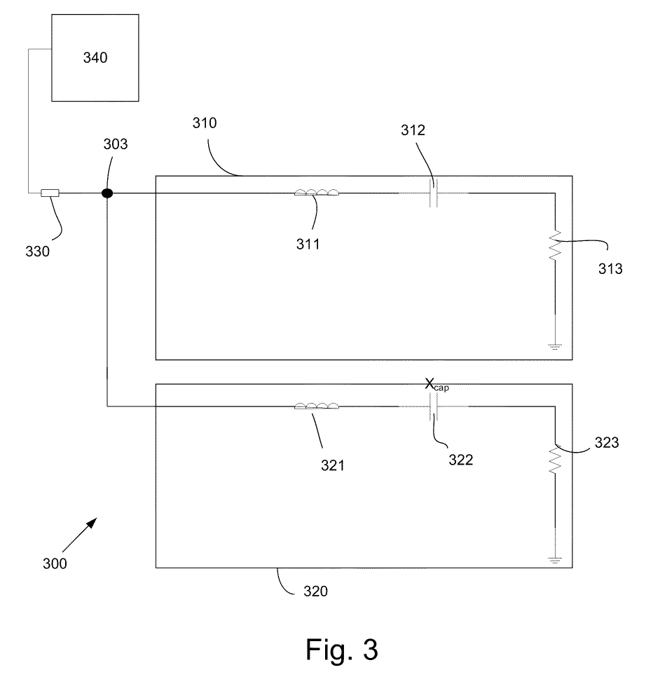

FIG. 3 is a diagram illustrating a schematic modelling of the two antenna elements according to aspects of the invention,

FIGS. 4-6 illustrate simulation results of antennas in different states,

FIG. 7 is a schematic of a communication device according to aspects of the invention, and

FIG. 8 is flow diagram according to aspects of the invention.

### DETAILED DESCRIPTION

Aspects of the invention introduce an alternative solution, which will be described in more detail below. The antenna system consistent with aspects of the invention does not require a switch. Two antenna elements are used as in the diversity scheme, but no switch mechanism is involved. Instead, the selection of the best antenna element is done automatically. The impact of the body will detune one antenna element (the antenna element closest to the body), which will result in a good power transfer to optimal driving (low reflection loss, insertion loss) the second antenna element (the antenna element furthest away from the body). This results in a system which hereinafter is called Autonomous Antenna Select System (AASS)

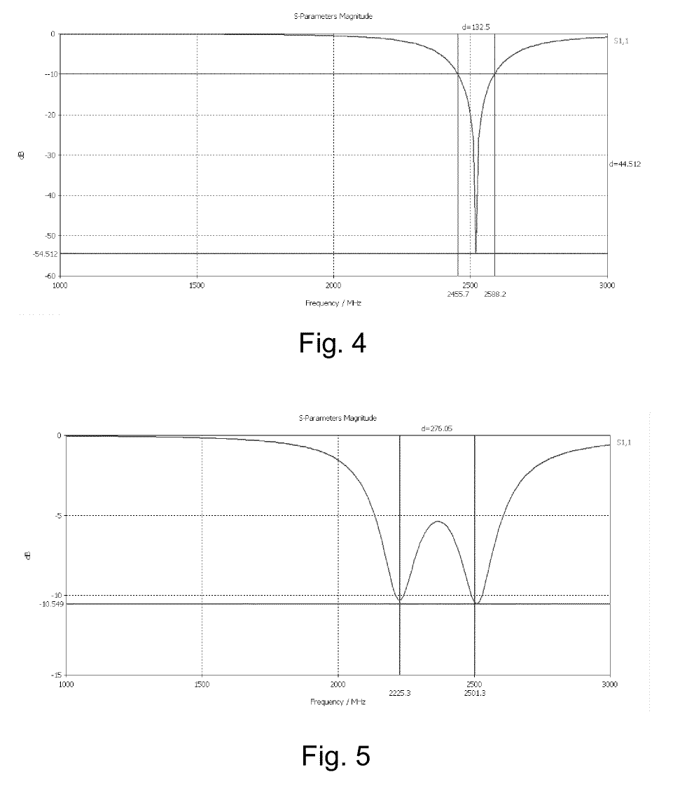

FIG. 3 illustrates an exemplary electrical schematic representation of the AASS. The system 300 comprises two antenna elements 310 and 320. Each antenna element 310 and 320 is modeled by a coil 311 and 321, a capacitance 312 and 322, and a series resistance 313 and 323. The series resistance 313/323 represents the radiation resistance. In an exemplary implementation, all energy dissipated in the radiation resistance is radiated as energy in the radio waves. The antenna elements are simply connected together to a driving point 330 of a transmitter-receiver portion. 303 designates a junction point.

Radiation resistance as used in this description relates to a part of an antenna's feed point resistance that is caused by the radiation of electromagnetic waves from the antenna. The radiation resistance is determined by the geometry of the antenna, not by the materials of which it is made. It can be viewed as the equivalent resistance to a resistor in the same circuit. Radiation resistance is caused by the radiation reaction of the conduction electrons in the antenna.

Although the method and arrangement has been shown to work for two antenna elements, the method can be extended to three or more antenna elements. The element closest to the body will be detuned and will automatically reflect more energy which is then exploited by the antenna elements further away from the body.

When there is no body (or an object with load) close by, the antenna elements will operate as a closely coupled antenna array. Both elements will have the same resonance frequency, and their S11 (reflection coefficient) response will coincide.

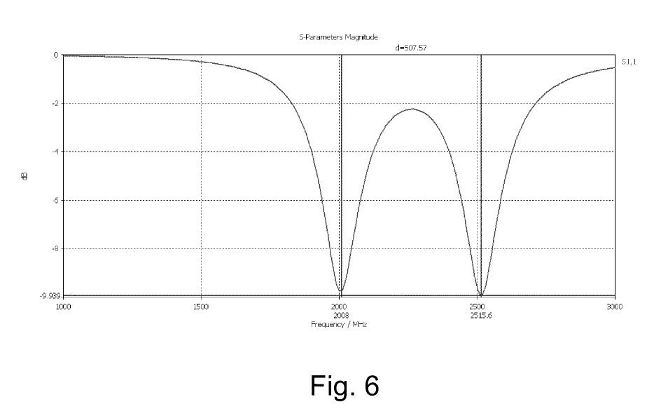

FIGS. 4 to 6 illustrate simulations results (S11/Frequency).

FIG. 4 illustrates the antennas in free space, i.e., there is no body load close by. For the simulations, port 1 has an impedance of 37.5 Ohms. The antennas are designed to resonate at 2.5 GHz and have a radiation impedance of 75 Ohms.

Simulations of a practical antenna have shown that in this case, the overall antenna efficiency can be close to 0 dB at 2.5 GHz depending on the material used directly around the antenna, and the material used to construct the antenna. Material losses such as conductive losses or dielectric losses can be represented as an additive series and/or parallel resistor to the radiation resistance, but without having the radiation properties, thus giving pure loss, resulting in an increase of thermal energy of the antenna system.

If a body is brought close to one of the antenna elements, e.g., antenna 320, this antenna is detuned and its resonance frequency drops. Effectively, this is caused by an increase in the series capacitance. This is because human tissue has a high effective permittivity εᵣ of around 47 which greatly increases the capacitance. The other antenna element, antenna 310, is hardly affected and is not detuned (or at least at a much smaller scale). The S11 response seen by the driving point is a combination of the S11 responses of the two individual S11 responses, as illustrated in FIG. 5.

In this case, antenna 320 is distanced 3 mm from the body. The physical distance between the antenna 320 and antenna 310 needs to be at a sufficient level to reach a satisfying total efficiency.

In this case, the antenna 320 shows a detuned resonance at 2.225 GHz. Although the reflection coefficient has increased at the desired resonance frequency, it has not been reduced completely.

Xcap represents the capacitance change due to body load. In free space, both antenna's have about the same capacitance. The inductance of the antenna is less influenced by the body load. According to this example, the inductance may be 60 nH at 2.44 GHz=+j920 Ohm and is a relative high impedance for e.g., a 37.5 Ohm driver. The capacitance may be 0.312 pF. All figures are given as examples and do not limit the invention to the specific figures. The invention may be achieved using components with other values.

If the antenna 320 is displaced to a closer distance to the body, this antenna is then further detuned, but there is still efficiency left at the 2.5 GHz resonance frequency due to a relative good reflection coefficient of antenna 310, as illustrated in FIG. 6.

Table 1 show simulation results with aid of a Three Dimensional Electro Magnetic simulator. Simulations show that improvement of 5dB efficiency is easily reached.

TABLE 1

| | Body distance to | Body distance | |
|---|---|---|---|
| | nearest antenna | to antenna is: | Free space |
| | is: 1 mm | 9 mm | Efficiency |
| No. of antennas | Efficiency (dB) | Efficiency (dB) | (dB) |
| single antenna system | −13.5 | | 0 |
| single antenna system | | −7.9 | |
| Two antenna's A.A.S.S. | −8.1 | | 0 |
| (The distance between | | | |
| both antennas on main | | | |
| PCB = 8 mm) | | | |
| Improvement due to | 5.4 | | 0 |
| A.A.S.S. (dB) | | | |

The performance is also controlled on a real product in practice and gives the measured results in table 2:

TABLE 2

| | Body distance to | Body distance to | |
|---|---|---|---|
| | nearest antenna is: | antenna is: | Free space |
| | 1 mm | 13 mm | Efficiency |
| No. of antennas | Efficiency (dB) | Efficiency (dB) | (dB) |
| single antenna | −14 | | −1 |
| system | | | |
| single antenna | | −6.7 | |
| system | | | |
| Two antenna's | −6.5 | | −1.5 |
| A.A.S.S. | | | |
| (The distance | | | |
| between both | | | |
| antennas on main | | | |
| PCB = 12 mm) | | | |
| Improvement due to | 7.5 | | −0.5 |
| A.A.S.S. (dB) | | | |

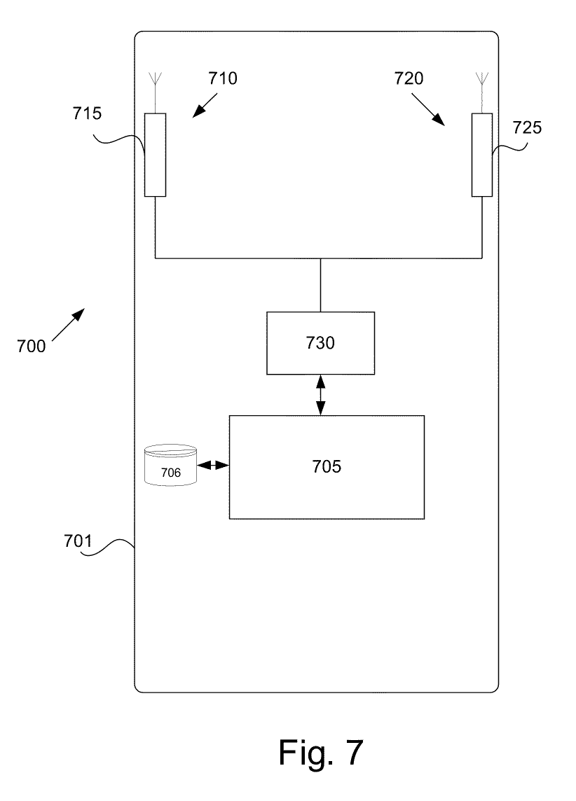

FIG. 7 illustrates a mobile or wearable communication device 700 for receiving and transmitting radio signals. As shown in FIG. 7, an exemplary device 700 may include a housing 701, a micro processor 705 (or data processing unit), a memory unit 706, communication portion 730. The device may further comprise a display, a keypad, a power source, a microphone and a speaker. These parts are not illustrated for reason of simplicity. The housing 701 may protect the components of device 700 from outside elements. A display may provide visual information to the user. For example, display may provide information regarding incoming or outgoing calls, media, games, phone books, the current time, a web browser etc. Control buttons (not shown) may be arranged to permit the user to interact with device to cause device to perform one or more operations. The keypad may include a standard telephone keypad. The microphone is used to receive ambient sound, such as the voice of the user.

The communication portion comprises parts (not shown) such as a receiver, a transmitter, (or a transceiver), antenna elements 710 and 720 etc., for establishing and performing communication with one or several communication networks (not shown). The antenna elements 710 and 720 each comprise a load portion 715 and 725 with certain impedance and radiating portions.

The radiating portions constituting the series resistance and all energy dissipated in the radiation resistance is radiated as energy in the radio waves. The antenna elements are simply connected together to a driving point of a transmitter-receiver portion 703.

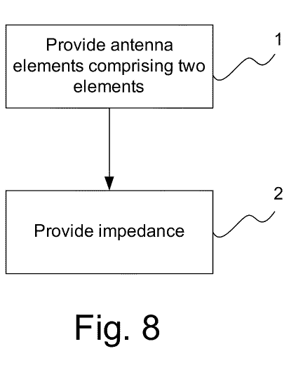

A method according to aspects of the invention for enhancing the radiation efficiency of the antenna system is illustrated in FIG. 8. Referring to FIG. 8, the method may include providing (block 1) at least two antenna elements distanced from each other and arranged substantially in parallel and connected to a common input/output. The method may also include providing (block 2) said antenna elements with a portion having an impedance such that said impedance is influenced by an external load such that one of said at least two antennas closest to said load is influenced by said load and detuned.

It should be noted that the word “comprising” does not exclude the presence of other elements or steps than those listed and the words “a” or “an” preceding an element do not exclude the presence of a plurality of such elements. It should further be noted that any reference signs do not limit the scope of the claims, that the invention may be implemented at least in part by means of both hardware and software, and that several “means”, “units” or “devices” may be represented by the same item of hardware.

A “device” as the term is used herein, is to be broadly interpreted to include a radiotelephone having ability for Internet/intranet access, web browser, organizer, calendar, a camera (e.g., video and/or still image camera), a sound recorder (e.g., a microphone), and/or global positioning system (GPS) receiver; a personal communications system (PCS) terminal that may combine a cellular radiotelephone with data processing; a personal digital assistant (PDA) that can include a radiotelephone or wireless communication system; a laptop; a camera (e.g., video and/or still image camera) having communication ability; and any other computation or communication device capable of transceiving, such as a personal computer, a home entertainment system, a television, etc.

The above mentioned and described embodiments are only given as examples and should not be limiting to the present invention. Other solutions, uses, and functions within the scope of the invention as claimed in the below described patent claims should be apparent for the person skilled in the art.

What we claim is:

1. An antenna system comprising:
at least two antenna elements distanced from each other and arranged substantially in parallel and connected to a common input/output for said antenna system, each of said antenna elements comprising:
a portion having an impedance such that said impedance is influenced by an external load such that one of said at least two antennas closest to said load is influenced by said load and detuned.

2. The antenna system of claim 1, wherein when said antenna element is detuned, it results in an optimal driving of the second antenna element.

3. The antenna system of claim 2, wherein said external load is a human body portion.

4. The antenna system of claim 1, wherein said antenna elements are configured to operate as a closely coupled antenna array, wherein said antenna elements have a same resonance frequency, and their reflection coefficient response coincide when there is no load influencing them.

5. A communication device comprising:
a transceiver portion and an antenna system comprising at least two antenna elements arranged distanced from each other and substantially in parallel and connected to a common input/output port for said antenna system, each of said antenna elements comprising:
a portion having an impedance such that said impedance is influenced by an external load such that one of said at least two antennas closest to said load is influenced by said load and detuned.

6. The device of claim 5, wherein when said antenna element is detuned, the second antenna element is optimally driven.

7. The device of claim 6, wherein said external load is a human body portion.

8. The device of claim 6, wherein said antenna elements are configured to operate as a closely coupled antenna array, wherein said antenna elements have a same resonance frequency, and their reflection coefficient response coincide when there is no load influencing them.

9. A method of enhancing radiation efficiency of an antenna system, the method comprising:
providing at least two antenna elements distanced from each other and arranged substantially in parallel and connected to a common input/output; and
providing said antenna elements with a portion having an impedance such that said impedance is influenced by an external load such that one of said at least two antennas closest to said load is influenced by said load and detuned.
